(19) United States
(12) Patent Application Publication
(10) Pub. No.: US 2013/0215552 A1
(43) Pub. Date: Aug. 22, 2013

(54) LAMINATED ELECTRONIC COMPONENT AND MANUFACTURING METHOD THEREOF

(71) Applicant: TAIYO YUDEN CO., LTD., (US)

(72) Inventor: Kenji SAITO, Takasaki-shi (JP)

(73) Assignee: TAIYO YUDEN CO., LTD., Tokyo (JP)

(21) Appl. No.: 13/769,034

(22) Filed: Feb. 15, 2013

(30) Foreign Application Priority Data
Feb. 16, 2012 (JP) 2012-031218

(51) Int. Cl. H01G 4/30

(52) U.S. Cl. CPC H01G 4/30
USPC 361/301.4; 156/150

(57) ABSTRACT

A laminated electronic component includes a laminate formed by alternately layering multiple internal electrodes and dielectrics, with the internal electrodes alternately exposed on the respective end faces of the laminate and two sets of external electrodes formed on them, wherein the external electrodes have a cermet layer that is film-formed by the sputtering method. Stable ESR (Equivalent Series Resistance) can be set over a wide range by changing the composition and film thickness of the cermet layer. In addition, ESR can be added that ensures low temperature coefficient and resistance to the impact of humidity change.

### BACKGROUND

1. Field of the Invention

The present invention relates to a laminated electronic component such as laminated ceramic capacitor, and particularly to a laminated electronic component whose ESR (Equivalent Series Resistance) can be adjusted, as well as a manufacturing method of said laminated electronic component.

2. Description of the Related Art

Laminated ceramic capacitors are structured by a ceramic laminate of roughly solid rectangular shape in which multiple internal electrodes and dielectric ceramics are alternately layered, wherein the layers of internal electrodes are alternately exposed on the different end faces of the ceramic laminate and two sets of external electrodes are formed on them. In general, the external electrodes are constituted by multiple conductive layers, such as base metal layers connected to the internal electrodes, plated metal layers designed to protect the base metal layers and improve the solder wettability, and the like.

Along with the trend for laminated ceramic capacitors of thinner layers and larger capacities in recent years, the ratio of internal electrodes in the laminate has become higher and the equivalent series resistance (hereinafter referred to as “ESR”) has trended lower. Laminated ceramic capacitors are characterized by their low ESR and have been used in applications where such low ESR serves as an advantage. However, if a lot of laminated ceramic capacitors of such low ESR are used to form a circuit, the impedance of the entire circuit becomes unnecessarily low. Particularly with a circuit used for a high frequency range, a resonance due to a given frequency is generated, which gives rise to the problem of a narrow operation frequency range.

Hitherto, various methods have been examined to add series resistance to laminated ceramic capacitors. For example, Patent Literature 1 discloses an invention constituted by a laminated ceramic capacitor with external electrodes which are electrically connected to the internal electrodes and on which a high-resistance semiconductor film layer is formed. With this laminated ceramic capacitor, Si (silicon) film is formed by the sputtering method as a high-resistance layer on the external electrodes.

In addition, Patent Literature 2 discloses a method to form a high-resistance layer on the external electrodes of a laminated ceramic capacitor at a low temperature, wherein the specific method uses conductive particles and curable resin.

In addition, Patent Literature 3 discloses a method to form a high-resistance layer on the external electrodes of a laminated ceramic capacitor, wherein the specific method is to apply a paste made of resistive material and then bake the paste at a high temperature of 600 to 850° C.

In addition, Patent Literature 4 discloses a method to form a high-resistance layer on the external electrodes of a laminated ceramic capacitor, wherein the specific method is to coat a resistive paste constituted by ruthenium oxide and glass frit and then dry the paste at a temperature of 150 to 200° C.

### BACKGROUND ART LITERATURES

### Patent Literatures

[Patent Literature 1] Japanese Patent Laid-open No. Hei 11-111563
[Patent Literature 2] Japanese Patent Laid-open No. Hei 11-283866
[Patent Literature 3] Japanese Patent Laid-open No. Hei 10-303066
[Patent Literature 4] Japanese Patent Laid-open No. Hei 5-283283

### SUMMARY

When an ESR function is added to a laminated ceramic capacitor using the method described in Patent Literature 1, the temperature coefficient of resistance becomes relatively high because the high-resistance layer uses semiconductor resistance film. As a result, a circuit in which such laminated ceramic capacitor is mounted causes the problem that the temperature stability of the circuit becomes lower.

In addition, producing a laminated ceramic capacitor using the method described in Patent Literature 2 gives rise to the problem of lower moisture resistance because the high-resistance layer uses resin.

In addition, the laminated ceramic capacitors described in Patent Literature 3 and Patent Literature 4 are such that their base electrodes formed by baking have a significant surface irregularity. When a resistive paste for forming the resistance layer is applied to a thickness of approx. 10 to 30 μm on these base electrode layers of irregular surface, the resulting high-resistance layer will have uneven film thickness and then the baking process is performed again. Because of this, resistance of the product will vary significantly. This gives rise to the problem that strict control of the ESR becomes difficult.

The present invention was made in light of the aforementioned problems, and its object is to provide a laminated electronic component offering improved ESR accuracy and high reliability, as well as a manufacturing method of such laminated electronic component.

The laminated electronic component pertaining to the present invention is (1) a laminated electronic component comprising a laminate formed by alternately layering multiple internal electrodes and dielectrics, with the internal electrodes exposed on the respective end faces of the laminate and external electrodes formed on them, wherein said laminated electronic component is characterized in that the external electrodes have a cermet layer that is film-formed by the sputtering method. (The foregoing is hereinafter referred to as the “first technical means under the present invention.”)

Additionally, one key embodiment of the aforementioned laminated electronic component is (2) a laminated electronic component characterized in that the cermet layer contains Ni in its composition. (The foregoing is hereinafter referred to as the “second technical means under the present invention.”)

Additionally, one key embodiment of the aforementioned laminated electronic component is (3) a laminated electronic component characterized in that the cermet layer is a connective layer directly contacting the internal electrodes. (The foregoing is hereinafter referred to as the “third technical means under the present invention.”)

Additionally, the manufacturing method of laminated electronic component pertaining to the present invention is (4) a manufacturing method characterized in that it includes a step to form a laminate by alternately layering multiple internal electrodes and dielectrics; a step to expose the internal electrodes to the respective end faces of the laminate; and a step to form a cermet layer which is film-formed by the sputtering method on the internal electrodes exposed on the end faces of the laminate. (The foregoing is hereinafter referred to as the “fourth technical means under the present invention.”)

The action and effects of the aforementioned first technical means are as follows. To be specific, providing on the external electrodes of a laminated electronic component a high-resistance layer constituted by a cermet film layer produced by the sputtering method allows for strict control of the film thickness of the cermet layer. As a result, ESR accuracy of the laminated electronic component can be improved. Since cermet can be formed by the sputtering method, dense cermet film can be formed to achieve ESR that also ensures excellent reliability in terms of moisture resistance, etc.

Furthermore, this cermet layer is different from the semiconductor layer made of Si, etc., as described in Patent Literature 1, in that it is characterized by a low temperature coefficient of resistance. As a result, the laminated electronic component can have improved temperature characteristics of ESR. In addition, resistance control becomes possible over a wide range by controlling the composition of cermet.

The action and effects of the aforementioned second technical means are as follows. To be specific, using a cermet layer composition containing Ni allows for ESR of 400 to 600 mΩ to be achieved even when the film thickness is several tens of nanometers.

The action and effects of the aforementioned third technical means are as follows. To be specific, by film-forming a cermet layer directly on the internal electrodes without surface preparation, a highly reliable laminated electronic component can be provided with simple steps.

The action and effects of the aforementioned fourth technical means are as follows. To be specific, by manufacturing a laminated electronic component through a step to expose the internal electrodes to the respective end faces of the laminate and a step to form a cermet layer which is film-formed by the sputtering method on the internal electrodes exposed on the end faces of the laminate, the laminated electronic component can have improved ESR accuracy. In addition, dense cermet film can be formed, and ESR can be achieved that also ensures excellent reliability in terms of moisture resistance, etc., as well as excellent temperature characteristics.

Any discussion of problems and solutions involved in the related art has been included in this disclosure solely for the purposes of providing a context for the present invention, and should not be taken as an admission that any or all of the discussion were known at the time the invention was made.

For purposes of summarizing aspects of the invention and the advantages achieved over the related art, certain objects and advantages of the invention are described in this disclosure. Of course, it is to be understood that not necessarily all such objects or advantages may be achieved in accordance with any particular embodiment of the invention. Thus, for example, those skilled in the art will recognize that the invention may be embodied or carried out in a manner that achieves or optimizes one advantage or group of advantages as taught herein without necessarily achieving other objects or advantages as may be taught or suggested herein.

Further aspects, features and advantages of this invention will become apparent from the detailed description which follows.

### BRIEF DESCRIPTION OF THE DRAWINGS

These and other features of this invention will now be described with reference to the drawings of preferred embodiments which are intended to illustrate and not to limit the invention. The drawings are greatly simplified for illustrative purposes and are not necessarily to scale.

FIG. 1 is a schematic cross-section view of a laminated electronic component pertaining to the present invention, with a cermet layer which is film-formed on the external electrodes

FIG. 2 is a diagram of frequency vs. impedance characteristics measured on laminated electronic components pertaining to the present invention, each with a cermet layer which is film-formed on the external electrodes

FIG. 3 is a diagram of frequency vs. impedance characteristics measured on a laminated electronic component without ESR for comparison

### DESCRIPTION OF THE SYMBOLS

10 Laminated electronic component
12 Dielectric layer
14 Internal electrode
16 Cermet layer
18 Cu external electrode
20 Ni-plated part
22 Sn-plated part

### DETAILED DESCRIPTION OF EMBODIMENTS

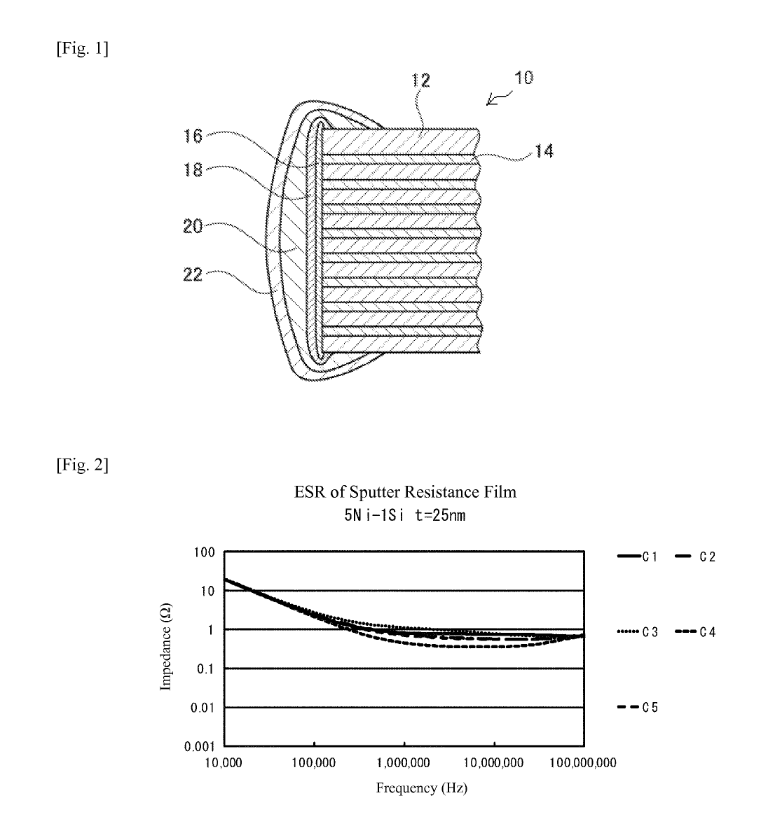

An embodiment of the laminated electronic component proposed by the present invention is explained by referring to the drawings. FIG. 1 is a cross-section view explaining an embodiment in which a laminated electronic component 10 pertaining to the present invention is applied as a laminated ceramic capacitor offering favorable temperature characteristics of capacitance as well as B characteristics.

The laminated electronic component 10 is structured in such a way that a dielectric layer 12 whose main component is barium titanate are alternately layered with internal electrodes 14.

For the dielectric layer 12 of the laminated electronic component 10, a composition powder of composite materials, primarily barium titanate, can be mixed with organic binder and solvent and a mixture is shaped into a sheet of approx. 5 μm in thickness using the doctor blade method, and the obtained sheet can be used. For the internal electrodes 14, the same sheet used for the dielectric layer 12 can be used after forming Ni patterns on it by the printing method.

Next, ten sheets of the dielectric 12 on which the internal electrodes 14 have been formed are layered and then thermally compressed to obtain a laminate, which is then cut to a specified shape. The cut laminate is such that the internal electrodes 14 are alternately exposed on the different end faces of the laminate. For example, a laminated electronic component 10 of the 1608 shape (1.6 mm×0.8 mm) that provides relatively more capacitance has external dimensions of 1.6 mm long×0.8 mm wide.

Next, the laminate cut to a specified shape is sintered in a reducing ambience of 1300° C. to obtain a chip-sintered compact. Next, a cermet layer 16 is film-formed by the sputtering method, as a connective layer directly contacting the end faces on which the internal electrodes 14 of the chip-sintered compact are exposed, in order to add ESR to the electrodes. Here, a cermet layer 16 constituted by a mixed layer of Ni and Si is film-formed with a film thickness of approx. 25 nm, for example. In addition to using the method of directly film-forming a cermet layer 16 on the end faces of the internal electrodes 14, a cermet layer 16 can also be film-formed after surface preparation.

After the cermet layer 16 has been film-formed, Cu external electrodes 18 are formed by the sputtering method for the purpose of surface protection and also to enhance the joining strength with the terminal surface. Thereafter, Ni-plated parts 20 and Sn-plated parts 22 are formed one by one to protect the Cu external electrodes 18 and also to form terminals offering improved solder wettability, to complete the laminated electronic component 10.

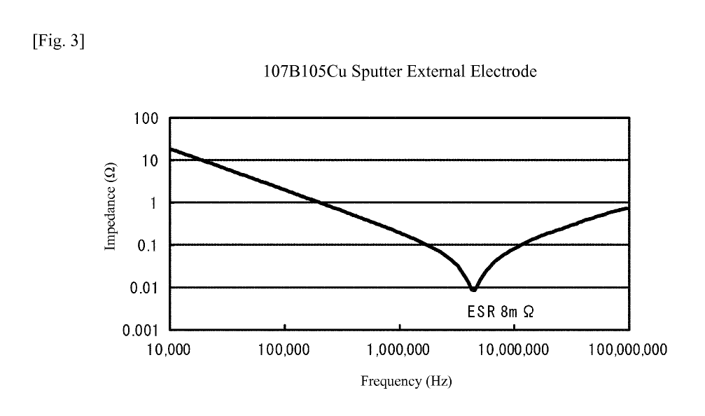

FIGS. 2 and 3 show the impedance measurement results of laminated ceramic capacitors. FIG. 2 is a diagram showing the relationship of frequency and impedance revealed by impedance measurement of multiple laminated ceramic capacitors on which a cermet film layer 16 was film-formed as a Ni—Si mixed layer of 25 nm in thickness to add ESR. FIG. 3 is a diagram showing the relationship of frequency and impedance of a laminated ceramic capacitor provided as a comparative sample, where a cermet layer 16 was not film-formed and Cu external electrodes 18 were film-formed directly by the sputtering method.

As shown in FIG. 2, the laminated ceramic capacitors pertaining to the present invention, each with a cermet layer 16 that is film-formed on the external electrodes, had ESR of 400 to 600 mΩ thereby achieving less variation in the resistance. It should be noted that the value and characteristics of ESR can be adjusted over a wide range by changing the thickness and composition of the cermet layer 16 as deemed appropriate.

On the other hand, as shown in FIG. 3, the laminated ceramic capacitor provided as a comparative sample, where cermet layer 16 was not film-formed and Cu external electrodes 18 were film-formed directly by the sputtering method, had ESR of 8 mΩ. By comparing FIGS. 2 and 3, it is determined that stable ESR can be achieved by presence of the cermet layer 16 pertaining to the present invention.

In the present disclosure where conditions and/or structures are not specified, a skilled artisan in the art can readily provide such conditions and/or structures, in view of the present disclosure, as a matter of routine experimentation. Also, in the present disclosure including the examples described above, any ranges applied in some embodiments may include or exclude the lower and/or upper endpoints, and any values of variables indicated may refer to precise values or approximate values and include equivalents, and may refer to average, median, representative, majority, etc. in some embodiments. Further, in this disclosure, an article “a” or “an” may refer to a species or a genus including multiple species, and “the invention” or “the present invention” may refer to at least one of the embodiments or aspects explicitly, necessarily, or inherently disclosed herein. In this disclosure, any defined meanings do not necessarily exclude ordinary and customary meanings in some embodiments.

The present application claims priority to Japanese Patent Application No. 2012-031218, filed Feb. 16, 2012, the disclosure of which is incorporated herein by reference in its entirety.

It will be understood by those of skill in the art that numerous and various modifications can be made without departing from the spirit of the present invention. Therefore, it should be clearly understood that the forms of the present invention are illustrative only and are not intended to limit the scope of the present invention.

We/I claim:

1. A laminated electronic component comprising a laminate formed by alternately layering multiple internal electrodes and dielectrics, wherein the internal electrodes are exposed on the respective end faces of the laminate and external electrodes are formed on the exposed ends of the internal electrodes, wherein the external electrodes includes a cermet layer which is film-formed by sputtering.

2. A laminated electronic component according to claim 1, wherein the cermet layer contains Ni in its composition.

3. A laminated electronic component according to claim 1, wherein the cermet layer is a connective layer physically contacting the ends of the internal electrodes.

4. A laminated electronic component according to claim 2, wherein the cermet layer is a connective layer physically contacting the ends of the internal electrodes.

5. A manufacturing method of a laminated electronic component, comprising:
a step to form a laminate by alternately layering multiple internal electrodes and dielectrics;
a step to expose the internal electrodes to the respective end faces of the laminate; and
a step to film-form a cermet layer by sputtering on the internal electrodes exposed on the end faces of the laminate.
